(19) United States
(12) Patent Application Publication
(10) Pub. No.: US 2007/0195010 A1
(43) Pub. Date: Aug. 23, 2007

(54) Display device

(75) Inventors: Hiroshi Toriumi, Tokyo (JP); Akio Fukushima, Tokyo (JP); Fumiko Kikuchi, Tokyo (JP); Koji Suzuki, Tokyo (JP); Naoko Ito, Tokyo (JP); Takayuki Kasuya, Tokyo (JP)

Correspondence Address: FOLEY AND LARDNER LLP;SUITE 500, 3000 K STREET NW, WASHINGTON, DC, 20007, US

(73) Assignee: PIONEER CORPORATION

(21) Appl. No.: 11/443,445

(22) Filed: May 31, 2006

(30) Foreign Application Priority Data
Feb. 17, 2006 (JP) 2006-041466

(51) Int. Cl. G09G 5/00

(52) U.S. Cl. 345/1.3

(57) ABSTRACT

A display unit displays an image, and includes plural independent image displays. A sound output unit outputs sound corresponding to an image displayed on the display unit. A storage unit stores image data of an image to be displayed on the display unit, sound data to be output by the sound output unit, and various kinds of content data. A switch detects various instructions input by a user. An input/output unit inputs and outputs image data and sound data communicated between the image displays. A power supply unit supplies a current to each functional unit. A controller controls display of an image on the display unit, while enlarging a single image displayed on a single image display to display enlarged image on an entire display unit, and reducing a single image displayed on the entire display unit to display reduced-sized image on a single image display.

### BACKGROUND OF THE INVENTION

1. Field of the Invention

The present invention relates to a display device having plural display units.

2. Description of the Related Art

In recent years, along with the development of information processing techniques, display devices applying various modes of display have been proposed to display various kinds of information (for example, see Japanese Patent Application Laid-Open (JP-A) Nos. H9-311737 and 2003-216134).

JP-A No. H9-311737 discloses a technique of a display device that includes plural independent display units and flexible joints that connect between these display units. This display device can be folded into a compact size. Different images can be displayed on each screen of each display unit.

JP-A No. 2003-216134 discloses a technique of a display device capable of displaying one image on an entire dome without a dead angle caused by audiences or devices.

The display device disclosed in JP-A No. H9-311737 is foldable, and is therefore convenient as a portable device. However, since the flexible joints must be removed every time the display device is folded, the display device is not very handy. Furthermore, the display device does not have a function of reducing a size of an image displayed on a screen unit formed with all of the display units to display the reduced-sized image on a single display unit with a simple operation. This display device does not have a function of increasing a size of an image displayed on one of the display units to display the enlarged image on the screen unit with a simple operation, neither.

The display device disclosed in JP-A No. 2003-216134 displays one image on a dome-shaped screen formed with plural display units, thereby eliminating a dead angle at which a part of the image is not displayed due to obstacles such as audiences and devices. However, this display does not have a function of reducing a size of an image displayed on the screen to display the reduced-sized image on a part of the screen with a simple operation. This display device does not have a function of increasing a size of an image displayed on a part of the dome-shaped screen to display the enlarged image on the entire screen with a simple operation, neither.

### SUMMARY OF THE INVENTION

It is an object of the present invention to at least solve the above problems in the conventional technologies.

A display device according to one aspect of the present invention includes a display unit including a plurality of displays, and configured to be foldable; a storage unit configured to store data including image data; and a controller configured to control the display unit to display an image, and to switch a display mode of the display unit between a first display mode and a second display mode, the first display mode in which the display unit displays a different image on each of the displays, the second display mode in which the display unit displays a single image selected from among images displayed on the displays, in an enlarged size.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a block diagram of a display device according to an embodiment of the present invention;

FIG. 2 is a schematic for illustrating an outline of functions of the display device according to the embodiment;

FIG. 3 is a schematic for illustrating a shape of the display device according to the embodiment;

FIG. 4 is a schematic of an image display having an operation function and a control function;

FIG. 5 is a schematic for illustrating one example of a bus line layer;

FIG. 6 is a schematic for illustrating another example of the bus line layer;

FIG. 7 is a schematic of an image display having an operation function, a control function, and a sound output function;

FIG. 8 is a schematic of an image display having an operation function, a control function, and a power supply;

FIG. 9 is a schematic of a connection member of the display device;

FIG. 10 is a schematic of the connection member;

FIG. 11 is a schematic for illustrating an outline of a flow of image data in the display device according to the embodiment;

FIG. 12 is a schematic for illustrating a start of an image enlargement process;

FIG. 13 is a schematic for illustrating transmission and reception of image data at the time of performing enlarged image display;

FIG. 14 is a schematic for illustrating transmission and reception of image data at the time of performing the enlarged image display;

FIG. 15 is a schematic for illustrating transmission and reception of image data at the time of performing the enlarged image display;

FIG. 16 is a schematic for illustrating transmission and reception of image data at the time of performing the enlarged image display;

FIG. 17 is a schematic for illustrating transmission and reception of image data at the time of performing the enlarged image display;

FIG. 18 is a schematic for illustrating transmission and reception of image data at the time of performing the enlarged image display;

FIG. 19 is a schematic for illustrating transmission and reception of image data at the time of performing the enlarged image display;

FIG. 20 is a schematic for illustrating transmission and reception of image data at the time of performing the enlarged image display;

FIG. 21 is a schematic for illustrating transmission and reception of image data at the time of performing the enlarged image display;

FIG. 22 is a schematic for illustrating transmission and reception of image data at the time of performing the enlarged image display;

FIG. 23 is a schematic for illustrating transmission and reception of image data at the time of performing the enlarged image display;

FIG. 24 is a schematic for illustrating transmission and reception of image data at the time of performing the enlarged image display;

FIG. 25 is a schematic for illustrating a start of an image reduction process;

FIG. 26 is a schematic for illustrating transmission and reception of image data at the time of performing reduced image display;

FIG. 27 is a schematic for illustrating transmission and reception of image data at the time of performing the reduced image display;

FIG. 28A is a flowchart of a processing performed by the display device according to the embodiment;

FIG. 28B is a flowchart of the processing performed by the display device according to the embodiment;

FIG. 28C is a flowchart of the processing performed by the display device according to the embodiment;

FIG. 28D is a flowchart of the processing performed by the display device according to the embodiment;

FIG. 28E is a flowchart of the processing performed by the display device according to the embodiment;

FIG. 28F is a flowchart of the processing performed by the display device according to the embodiment; and

FIG. 28G is a flowchart of the processing performed by the display device according to the embodiment.

### DETAILED DESCRIPTION OF THE PREFERRED EMBODIMENTS

Exemplary embodiments according to the present invention will be explained in detail below with reference to the accompanying drawings.

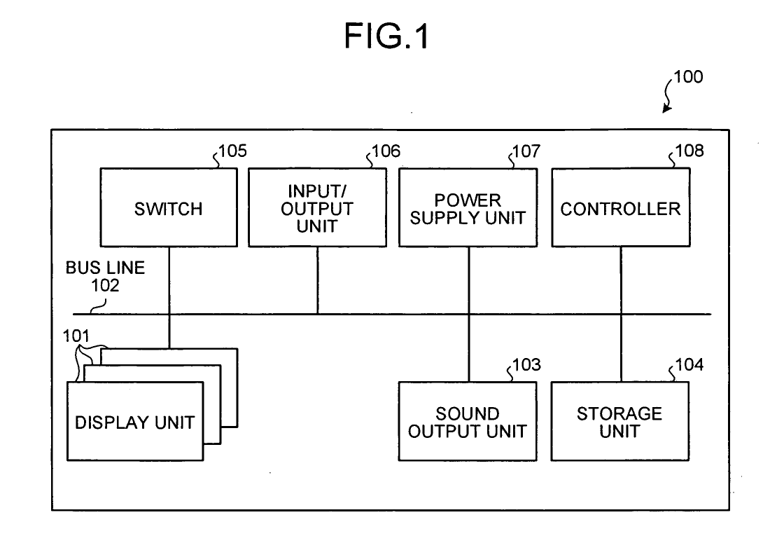

FIG. 1 is a block diagram of s display device according to an embodiment of the present invention. As shown in FIG. 1, a display device 100 includes a display unit 101, a bus line 102, a sound output unit 103, a storage unit 104, a switch 105, an input/output unit 106, a power supply unit 107, and a controller 108. These functional units are connected to each other via the bus line 102.

The display unit 101 displays an image, and includes plural independent image displays. Each image display includes a film material or a glass substrate having a parallelogram, diamond, or a trapezoid shape. When each image display is to be configured using a diamond film material or glass substrate, the diamond film material or the glass substrate can be configured by two triangular film materials or glass substrates.

The sound output unit 103 outputs sound corresponding to an image displayed on the display unit 101.

The storage unit 104 stores various kinds of content data such as image data to be displayed on the display unit 101 and sound data to be output from the sound output unit 103, and management information such as an address on a memory and a table of contents. The storage unit 104 also stores a control program of the display device 100. The storage unit 104 also has a function of holding an operation menu screen as a user interface, set information (such as a display color and an initialization mode) that is set by a user, and information concerning last content data that viewed at last use.

The switch 105 detects each instruction that is input by a user. The switch 105 may include a function as a receiver that receives an instruction sent by a remote control.

The input/output unit 106 communicates content data such as image data and sound data transferred from the outside, and obtains the content data via various transmission paths such as a recording medium. The obtained content data is stored in the storage unit 104. The input/output unit 106 outputs content data from the display device 100 to the outside. For example, the input/output unit 106 is connected to a headphone as an acoustic device. With this arrangement, the user can listen to sound corresponding to an image displayed on the display unit 101, via the headphone. When a monitor as a second display device separate from the display device 100 is available around the display device 100, the content data can be output to the second display device. The input/output unit 106 can correspond to the input and output of data using various transmission mediums such as a line, electromagnetic waves, optical networking, and memory cards.

Since the display device 100 includes the storage unit 104, an image (or a storage address of the image data on the memory) that is last displayed on the display unit 101 can be stored, based on the process performed by the controller 108, when the power supply is turned off. When the power supply is turned on, the display unit 101 can display again the image stored in the storage unit 104.

The power supply unit 107 includes a sheet cell, and can supply current to the functional units 101 to 109.

The controller 108 operates based on a control program stored in the storage unit 104, and performs the total control of the display device 100.

The bus line 102 is a signal control line that connects between the functional units, and transmits various signals and data between the functional units.

The display device 100 of the present embodiment is configured by laminating the display unit 101, the sound output unit 103, the storage unit 104, the switch 105, the input/output unit 106, the power supply unit 107, the controller 108, and the bus line 102. The display device 100 is regularly folded at a connection part of the image displays connected with connection members.

This display device 100 has a configuration in which plural image displays can be folded into a completely folded state by superimposition onto one image display. Specifically, the display device 100 is configured such that a total surface of the display device 100 in a completely folded state is smaller than a size of two image displays laid out together.

When the image displays are connected together with the connection members such that each image display is mountain folded or valley folded, the display unit 101 can be folded. When the Miura folding (registered trademark) method is applied, the image displays can be enlarged and contracted in one axis direction, thereby easily opening and closing the image displays. In other words, when the Miura folding method is applied to the display unit 101, two different opposite ends of the display unit 101 in a completely enlarged state can be quickly pulled to the left and right directions so that the display unit 101 can be enlarged momentarily. The display unit 101 can be also folded momentarily.

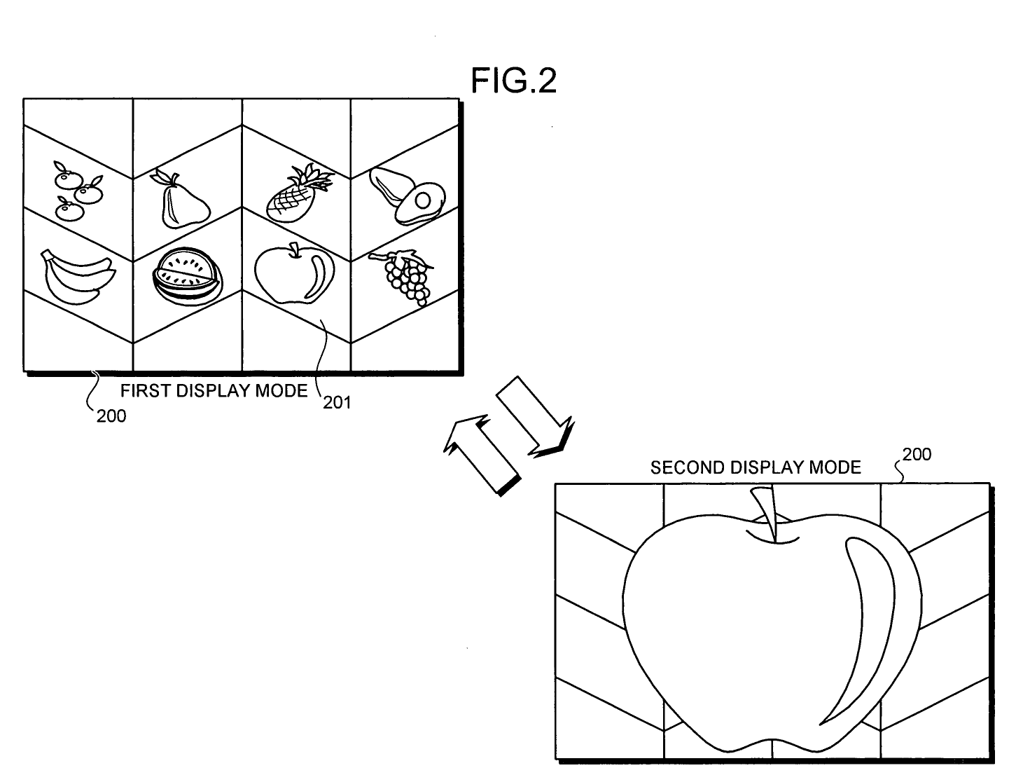

FIG. 2 is a schematic for illustrating an outline of the functions of the display device according to the embodiment. As described above, the display device 100 according to the present embodiment includes plural independent image displays. Therefore, different images can be displayed on the respective image displays (a first display mode). An image displayed on one image display 201 that constitutes a display unit 200 of the display device 100 can be displayed by expansion in the total display unit 200 (a second display mode). Furthermore, an image displayed on the total display unit 200 can be displayed by reduction on one of the image displays 201 that constitute the display unit 200. As explained above, images can be displayed by switching between the first display mode and the second display mode.

An image to be displayed as an enlarged image (an image to be displayed in the second display mode) may be selected by a user, or may be automatically selected based on a program installed in advance. The user can operate or instruct to switch from an enlarged display (the first display mode) to a display (the first display mode) of different images in the individual image displays 201, or this image display can be automatically switched based on a program installed in advance, for example, after a lapse of a predetermined time.

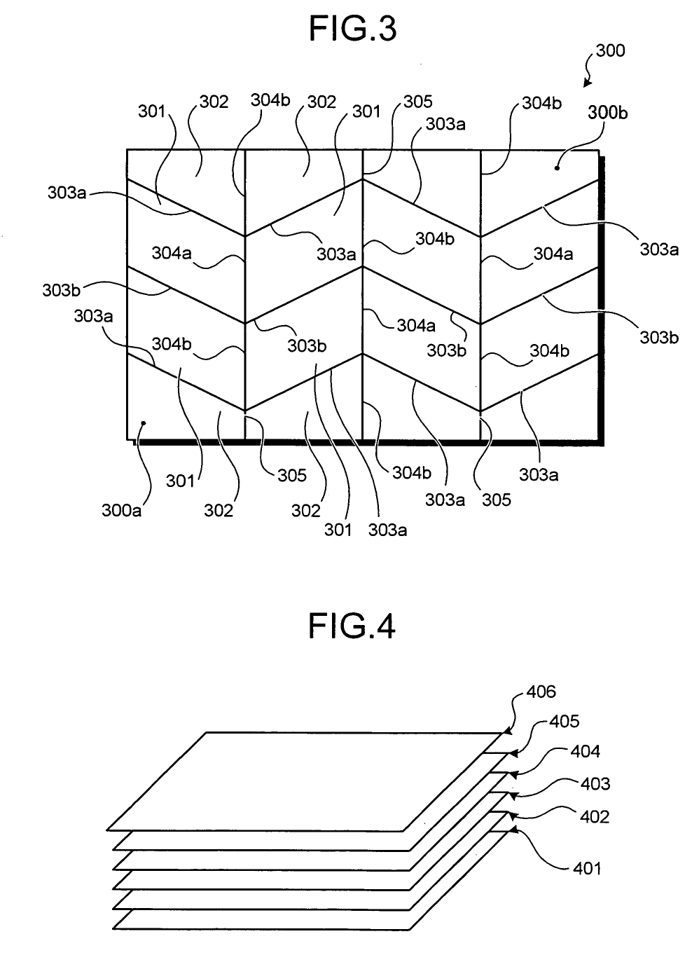

FIG. 3 is a schematic for illustrating a shape of the display device according to the embodiment. A display device 300 includes plural parallelogram image displays 301, plural trapezoidal image displays 302, and connection members 303a, 303b, 304a, 304b, and 305 that connect between these image displays 301 and 302.

When the Miura folding method is used to fold the display device 300, the display device 300 can be enlarged and contracted in one axis direction, thereby facilitating opening and closing of the display device 300. In other words, by using the Miura folding method, two different opposite ends of the display device 300 that is in a completely enlarged state can be quickly pulled to the left and right directions, thereby expanding the display device 300 momentarily. The display device 300 can be also folded momentarily. This display device 300 can be also folded using a method other than the Miura folding method.

The connection members 303a, 303b, 304a, 304b, and 305 have displacement detectors that generate a potential according to displacement (an opening level) of the image displays 302. When a controller (not shown) detects a magnitude of a potential generated by the displacement detector, the controller can determine whether the display device 300 is in a state of being opened by a predetermined level from a completely folded state or the display device 300 is in a state of being folded to a predetermined level from a completely enlarged state. When the display device 300 is opened to a predetermined level from the completely folded state, a power supply unit (not shown) starts supplying a current to each functional unit. When the display device 300 is folded to a predetermined level from the completely enlarged state, the power supply unit stops supplying a current to each functional unit.

The parallelogram image displays 301 have the same sizes, and are configured by a film material or a glass substrate. The trapezoidal image displays 302 also have the same sizes, and are configured by a film material or a glass substrate. In the display device 300 shown in FIG. 3, the parallelogram image displays 301 and the trapezoidal image displays 302 are combined together to form a rectangular display screen.

The connection members 303a and 303b connect between the image displays 301 and the image displays 302, or between the image displays 301, that are laid out in a vertical direction in FIG. 3. The connection members 304a and 304b connect between the image displays 301 or between lower bases of the image displays 302, that are laid out in a lateral direction in FIG. 3. The connection members 305 connect between upper bases of the image displays 302 that are laid out in a lateral direction.

When the connection members 303a, 303b, 304a, 304b, and 305 are configured by hinges or a resin material, the display device 300 can be folded using the connection members 303a, 303b, 304a, 304b, and 305 as folding lines. In this case, the Miura folding method can be used to fold the display device 300. With this arrangement, the display device 300 can be folded by alternately making the mountain folding and the valley folding.

In other words, at first, the display device 300 is mountain folded along the connection member 303a, and is then valley folded along the connection member 303b. Then, the display device 300 is mountain folded along the connection member 304a, is valley folded along the connection member 304b, and is then mountain folded along the connection member 305. With this arrangement, the display device 300 can be enlarged momentarily by pinching and pulling both ends of the parts 300a and 300b to the left and right directions for example. The display device 300 can be folded by pinching the parts 300a ad 300b and lightly pressing these parts.

A configuration of each image display that constitutes the display device 300 is explained next.

FIG. 4 is a schematic of an image display having an operation function and a control function. This image display has a semiconductor layer 402, a bus line layer 403, a display layer 404, an operation detection layer 405, and a protection layer 406 that are sequentially laminated on a base layer 401. The semiconductor layer 402 includes an organic semiconductor and the like. The semiconductor layer 402 performs total control of the image display, and can also control other image displays. The semiconductor layer 402 has a storage function of storing image data to be displayed on the display layer 404, sound data to be output from an oscillation layer described later, various content data, a control program of the display device 300, and the like. The semiconductor layer 402 can be also configured to form a video memory, a buffer memory, and a display control integrated circuit (IC) to be used to display an image. The bus line layer 403 guides image data, sound data, a control signal, a current, and the like to each functional unit of the image display and to other image displays. The bus line layer 403 has a transmitting and receiving unit that transmits and receives various kinds of image data, control signals, and the like to and from other image displays, as described in detail later. The display layer 404 includes an organic electroluminescent (EL) display, a liquid crystal display, or a thin display such as an electronic paper, to display an image. The operation detection layer 405 corresponds to the switch 105 shown in FIG. 1, and includes a touch panel for detecting information input by the user. Therefore, when the user presses the operation detection layer 405 via the protection layer 406 from above this layer with fingers or the like, the user can control the display device 300. The protection layer 406 is made of a transparent resin or the like, and protects the operation detection layer 405.

The display device 300 according to the embodiment transmits and receives various image data, control signals, and the like via the bus line layer 403 provided in each image display. Therefore, a transmitting and receiving unit (communication unit) that transmits and receives various data, control signals, and the like is provided in the bus line layer 403.

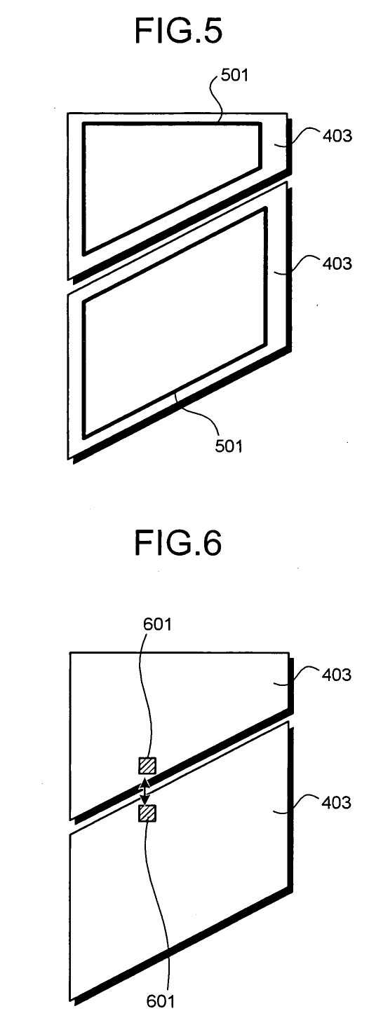

FIG. 5 and FIG. 6 are schematics for illustrating examples of the bus line layer 403. FIG. 5 illustrates an example of a provision of a loop antenna 501 configured by a transparent electrode near the external periphery of the bus line layer 403. When the loop antenna 501 is provided in the bus line layer 403, various data and the like are exchanged with among respective image displays, using an electromagnetic wave. FIG. 6 illustrates an example of a provision of an optical transmitter/receiver 601 in the bus line layer 403. When the optical transmitter/receiver 601 is provided in the bus line layer 403, various data and the like are exchanged among respective image displays by optical communications. By thus configuring the bus line layer 403, various data and the like can be transmitted and received, without providing a film-shaped bus line between the image displays. Therefore, when the image display device is configured to be foldable at the connection part between the image displays, durability to folding of the device can be improved.

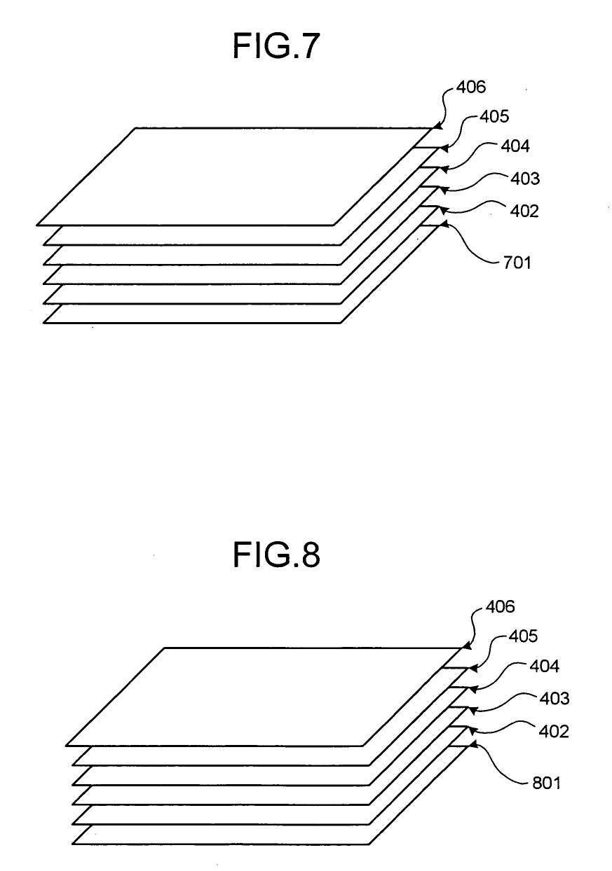

FIG. 7 is a schematic of an image display having an operation function, a control function, and a sound output function. This image display has the semiconductor layer 402, the bus line layer 403, the display layer 404, the operation detection layer 405, and the protection layer 406 that are sequentially laminated on an oscillation layer 701. The oscillation layer 701 is formed to have the same thickness as that of the base layer 401 shown in FIG. 4, and can output sound data transmitted via the bus line layer 403. This oscillation layer 701 is what is called a speaker, and corresponds to the sound output unit 103 shown in FIG. 1. Under the control of the controller 108, the oscillation layer 701 oscillates to generate sound based on sound data read from the storage unit 104.

FIG. 8 is a schematic of an image display having an operation function, a control function, and a power supply. This image display has the semiconductor layer 402, the bus line layer 403, the display layer 404, the operation detection layer 405, and the protection layer 406 that are sequentially laminated on a sheet power supply layer 801. The sheet power supply layer 801 is formed to have the same thickness as that of the base layer 401 shown in FIG. 4, and can supply a current to the display layer 404 and other image displays. Since this image display has the sheet power supply layer 801, the image display can perform an image display control, without receiving a current supply from other supply source.

The display device 300 according to the embodiment of the present invention can be provided by connecting plural image displays shown in FIGS. 4, 7, and 8. Each of these image displays has six layers, and each layer has the same thickness. Therefore, the display device 300 can be provided by connecting these image displays, without a problem of different thicknesses in the display device 300. Layout positions of these image displays that constitute the display device 300 are different depending on required functions of the display device. At least one of the image displays shown in FIG. 7 and FIG. 8 is necessary.

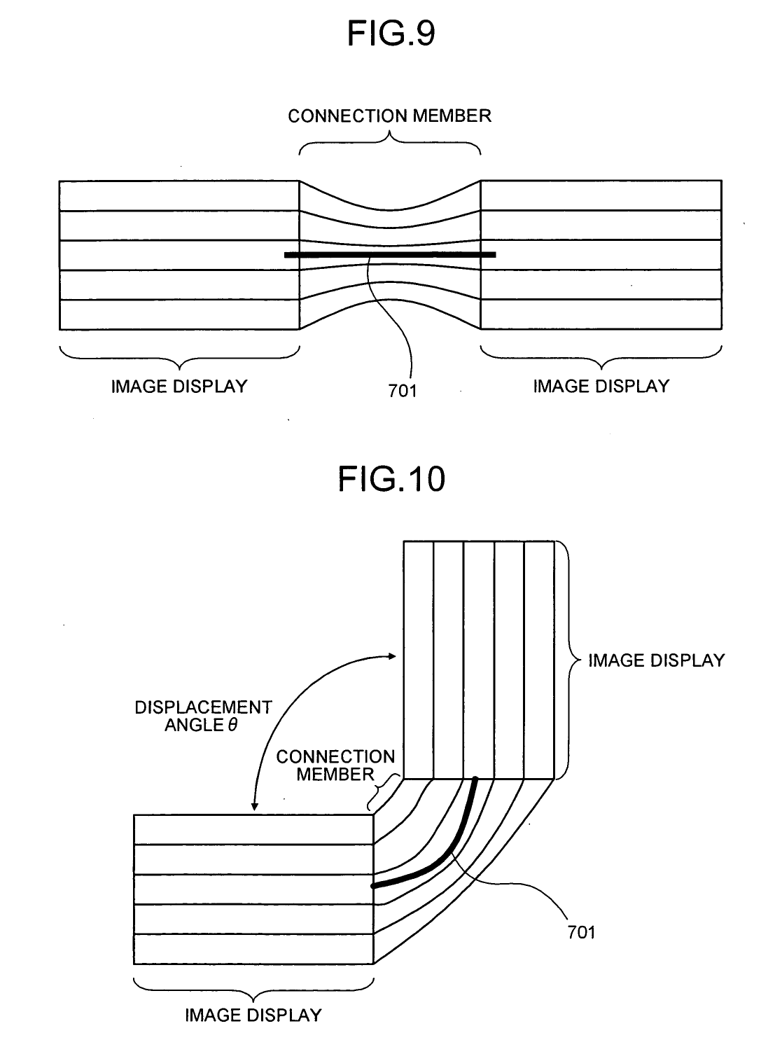

FIG. 9 and FIG. 10 are schematics of the connection members of the display device 300. As shown in FIG. 8, the display device 300 has image displays that are connected together with flexible connection members. A displacement detection film 901 is provided inside the connection members. When the displacement detection film 901 is bent at a displacement angle θ from a shape shown in FIG. 9, the shape changes as shown in FIG. 10. The displacement detection film 901 generates a potential proportional to this displacement. Therefore, the controller provided in the semiconductor layer 402 of the image display having the control function shown in FIG. 4 monitors the magnitude of the current generated by the displacement detection film 901, thereby detecting a change of the current and obtaining displacement. As a result, the controller can detect an inclination (an opening level) of the image displays. When a turning on and a turning off of the power supply is controlled based on a result of the detection of the displacement by the displacement detection film 901, the power supply can be turned on or turned off by only opening and closing the display device 300, without using a power supply switch.

When the display device has three or more image displays, there are two or more connection parts between the image displays. In this case, an output of each displacement detection film 901 provided at each connection part is transmitted to an image display having the control function, via the bus line layer 403 that functions as a bus line. The controller detects a total shape change of the display device 300, and can determine whether the display device 300 is in the opened state or the closed state.

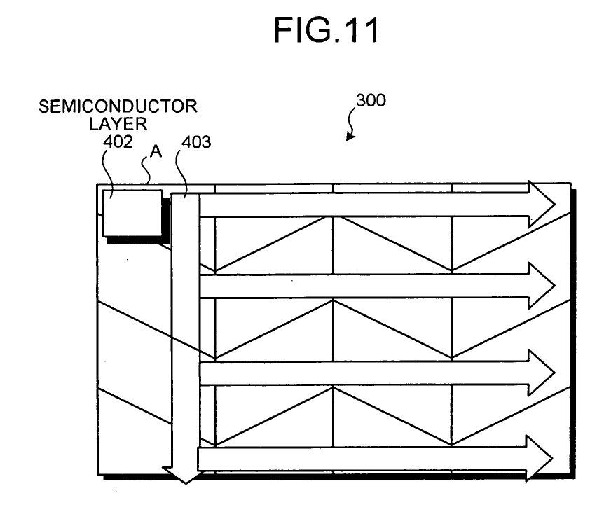

FIG. 11 is a schematic for illustrating an outline of a flow of image data in the display device according to the present embodiment. In this image display device 300, an image display that controls the entire device is selected in advance (an image display A at a left upper corner, in the example shown in FIG. 11). The semiconductor layer of the image display A stores in advance a control program for controlling the entire display device and various kinds of content data. When the semiconductor layer of the image display A is configured to have a larger storage capacity than that of semiconductor layers of image displays other than the image display A, the semiconductor layer of the image display A can store audio visual (AV) data including images and sounds.

The controller (semiconductor layer 402) of the image display A transmits image data to all the image displays via the bus line layer 403. The transmitted image data is coded and modulated. Each image display that receives the image data also has the controller (the semiconductor layer 402). This controller decodes and demodulates the obtained image data, and displays the image. Each image display is allocated with an address. Each image display displays the image data corresponding to the own address from among the received image data. A decoder provided in the display layer of each image display performs this process. The image data distributed via the bus line layer 403 as a communication unit from the image display A is stored in a storage area of the semiconductor layer of each image display. Each semiconductor layer of the image display other than the image display A can have a smaller storage capacity than that of the image display A. It is needless to mention that all semiconductor layers of the image displays can have the same storage capacity as that of the semiconductor layer of the image display A.

One example of the process of the display device 300 according to the embodiment of the present invention is explained next. The display device 300 includes 16 image displays. A memory (corresponding to the semiconductor layer 402) of each image display holds image data that is displayed on the image display. In other words, each image display is already distributed with image data to be displayed on the image display, from the image display A. Each image display displays a reduced image of the image displayed on the original display area.

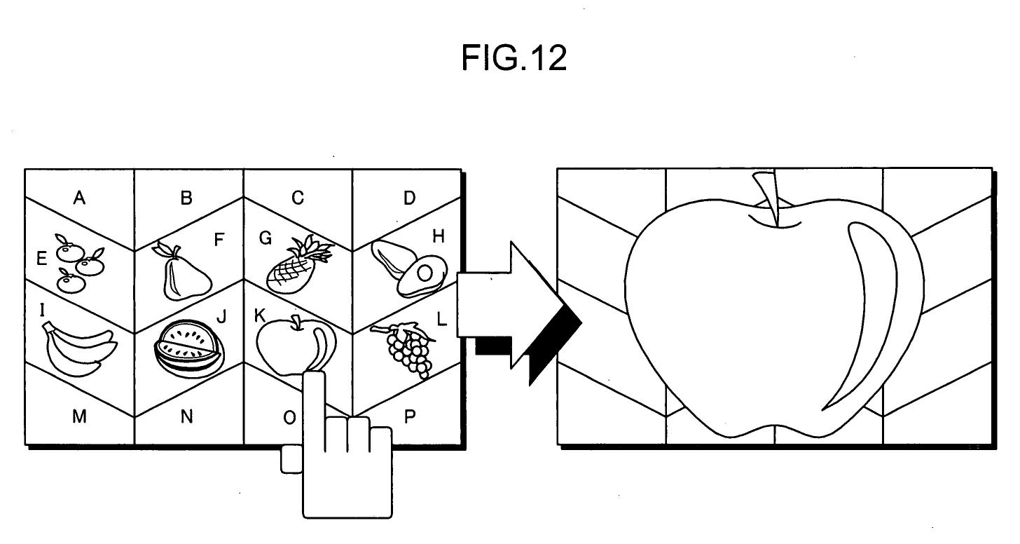

FIG. 12 is a schematic fro illustrating a start of an image enlargement process. A to P in FIG. 12 denote image displays. As shown in FIG. 12, to display an image displayed on one of these image displays (“K”, for example) in the whole device, a display surface of the image display “K” is tapped twice with the fingers. Since each image display has the operation detection layer 405 as described above, this control becomes possible. When the image display “K” detects that the display surface is tapped twice with the fingers, the image display “K” transmits the own image data to all the image displays. Each image display that receives the image data displays only a corresponding part of the received image to be displayed by the own image display, because each image display knows what part of the received image should be displayed. As a result, an enlarged image of the image display “K” can be displayed on the total image displays.

In performing an enlarged display of an image, what kind of method is to be used to efficiently transmit and receive the image data between the image displays becomes a matter to be determined. Particularly, when it becomes impossible to transmit or receive image data between the target image displays for some reason (for example, a failure of a communication element such as the loop antenna and an optical transmitter/receiver), a method of avoiding this problem should be determined. In the present embodiment, image data is transmitted and received, according to the following rules (1) to (7).

(1) A communication order between the image displays is set as “left”, “top”, “right”, and “bottom”, based on the position of the image display that is to transmit image data. This order is not limited, so long as the communication order is constant in four directions of the image display. For example, all the image displays can transmit image data in the order of “top”, “bottom”, “left”, and “right”.

(2) Assume that when the image display “A” detects a carrier of the data line in an attempt to communicate with an adjacent image display “B”, an image display “C” has earlier started communications with the image display “B”. In this case, the image display “A” generates a random timer in the image display “A”, and starts communications with the image display “B” again after a lapse of a predetermined time.

(3) When a communication flag is set in an image display to which a certain image display tries to transmit image data, the image display communicates with an image display next to the image display in which this flag is set.

(4) When an image display obtains new image data, this image display saves the image data that has been held so far by the self, and displays a corresponding part of the total image based on the image data received this time.

(5) When an image display that tries to transmit image data detects that a communication flag is set in all surrounding image displays, that is, when there is no adjacent image display to which the image data can be transmitted, the image display immediately ends the communication.

(6) An image display that has ended data communication reports the end of the communication to the controller (the semiconductor layer 402) of the image display that controls the entire image display device.

(7) An image display that has ended data communication waits for a command to return to the original display (the reduced image display) mode.

Transmission and reception of image data between image displays is explained below with reference to the drawings.

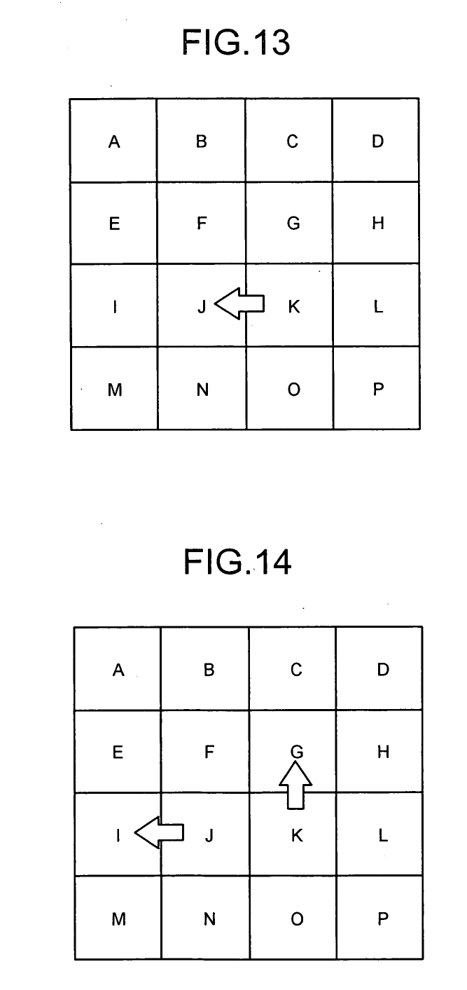

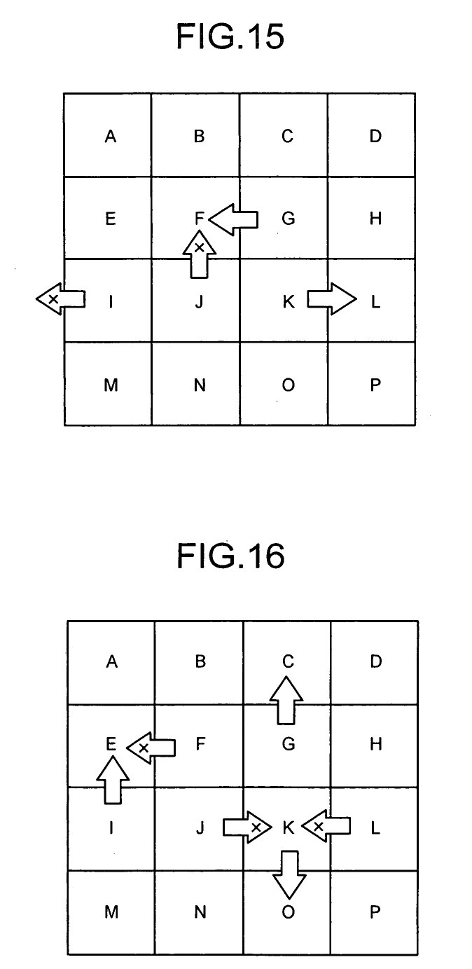

FIG. 13 to FIG. 24 are schematics for illustrating transmission and reception at the time of performing an enlarged image display. As shown in FIG. 13, it is assumed that image data is transmitted from an image display “K”. “K” starts transmission of image data to “J” that is positioned at the left side of “K”. Then, as shown in FIG. 14, “K” transmits image data to “G” that is positioned above “K”. On the other hand, “J” also transmits image data to “I” that is positioned at the left side of “J”. As shown in FIG. 15, “K” transmits image data to “L” that is positioned at the right side of “K”. “G” transmits image data to “F” that is positioned at the left side of “G”. Since there is no communication party at the left side of “I”, “I” does not transmit image data to the left side. Since “F” has earlier started communication with “K”, “J” does not transmit image data to “F” that is positioned above “J”.

As shown in FIG. 16, “K” transmits image data to “O” that is positioned below “K”. Since “K” has ended communication, “J” and “L” do not transmit image data to “K”. “I” transmits image data to “E” that is positioned above “I”. Since “E” has earlier started communication with “I”, “F” does not transmit image data to “E” that is positioned at the left side of “F”. “G” transmits image data to “C” that is positioned above “G”.

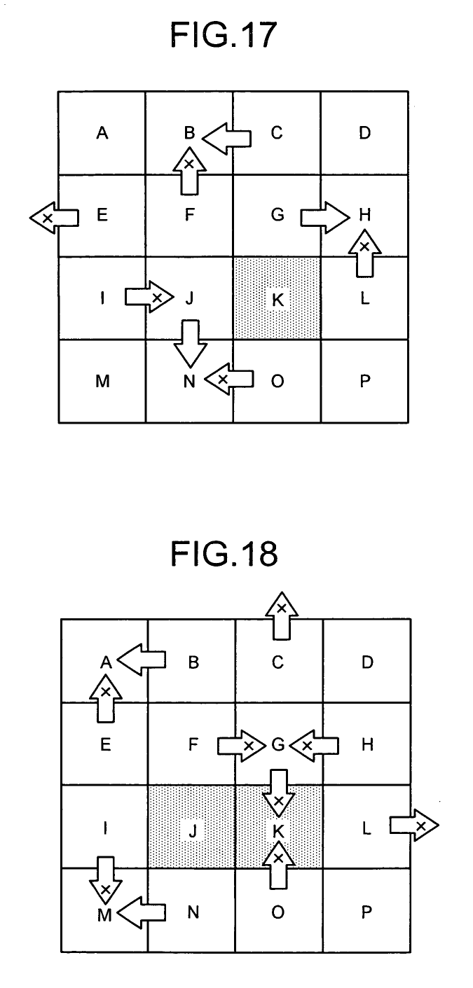

As shown in FIG. 17, “K” has ended communication, and displays a corresponding part of the image. “J” transmits image data to “N” that is positioned below “J”. Since “J” has ended communication, “I” does not transmit image data to “J” that is positioned at the right side of “I”. Since “N” has earlier started communication with “J”, “O” does not transmit image data to “N” that is positioned at the left side of “O”. Since there is no communication party at the left side of “E”, “E” does not transmit image data to the left side. “G” transmits image data to “H” that is positioned at the right side of “G”. Since “H” has earlier started communication with “G”, “L” does not transmit image data to “H” that is positioned above “L”. “C” transmits image data to “B” that is positioned at the left side of “C”. Since “B” has earlier started communication with “C”, “F” does not transmit image data to “B” that is positioned above “F”.

As shown in FIG. 18, “J” has ended communication, and displays a corresponding part of the image. Since “K” has ended communication, “G” and “O” do not transmit image data to “K”. Since “G” has ended communication, “F” and “H” do not transmit image data to “G”. Since there is no communication party above “C”, “C” does not transmit image data to the above. Since there is no communication party at the right side of “L”, “L” does not transmit image data to the right side of “L”. “B” transmits image data to “A” that is positioned at the left side thereof. Since “A” has earlier started communication with “B”, “E” does not transmit image data to “A” that is positioned above “E”. “N” transmits image data to “M” that is positioned at the left side of “N”. Since “M” has earlier started communication with “N”, “I” does not transmit image data to “M” that is positioned below thereof.

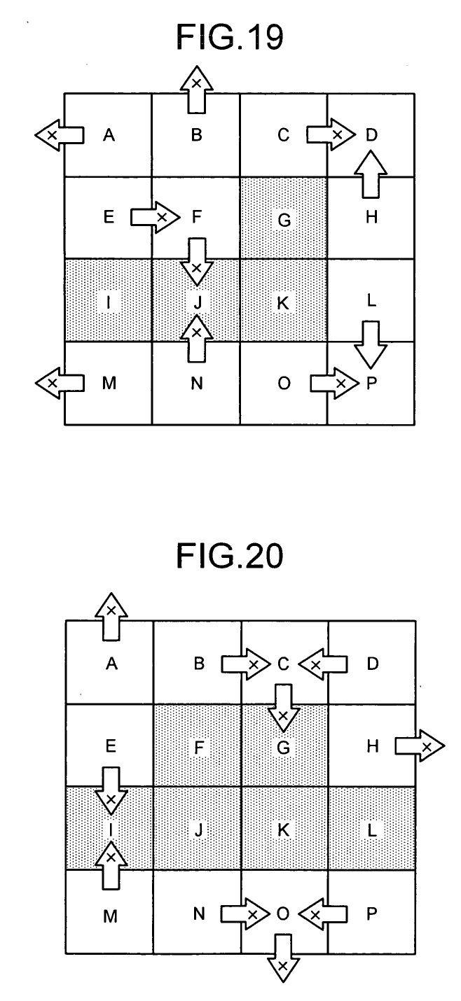

As shown in FIG. 19, “G” and “I” have ended communication, and display a corresponding part of the image, respectively. Since “J” has already ended communication, “F” and “N” do not transmit image data to “J”. Since “F” has also ended communication, “E” does not transmit image data to “F” that is positioned at the right side of “E”. “L” transmits image data to “P” that is positioned below “L”. Since “P” has earlier started communication with “L”, “O” does not transmit image data to “P” that is positioned at the right side of “O”. “H” transmits image data to “D” that is positioned above “H”. Since “D” has earlier started communication with “H”, “C” does not transmit image data to “D” that is positioned at the right side of “C”. Since there is no communication party above “B”, “B” does not transmit image data to the above. Since “A” and “M” do not have a communication party at the left side of “A” and “M” respectively, “A” and “M” do not transmit image data to the left side.

As shown in FIG. 20, “F” and “L” have ended communication, and display a corresponding part of the image, respectively. Since “I” has already ended communication, “E” and “M” do not transmit image data to “I”. Since “G” has already ended communication, “C” does not transmit image data to “G”. Since “C” has already ended communication, “B” and “D” do not transmit image data to “C”. Since there is no communication party below “O”, “O” does not transmit image data to below thereof. Since “O” has ended communication, “P” and “N” do not transmit image data to “O”. Since there is no communication party at the right side of “H”, “H” does not transmit image data to the right side thereof. Since there is no communication party above “A”, “A” does not transmit image data to the above.

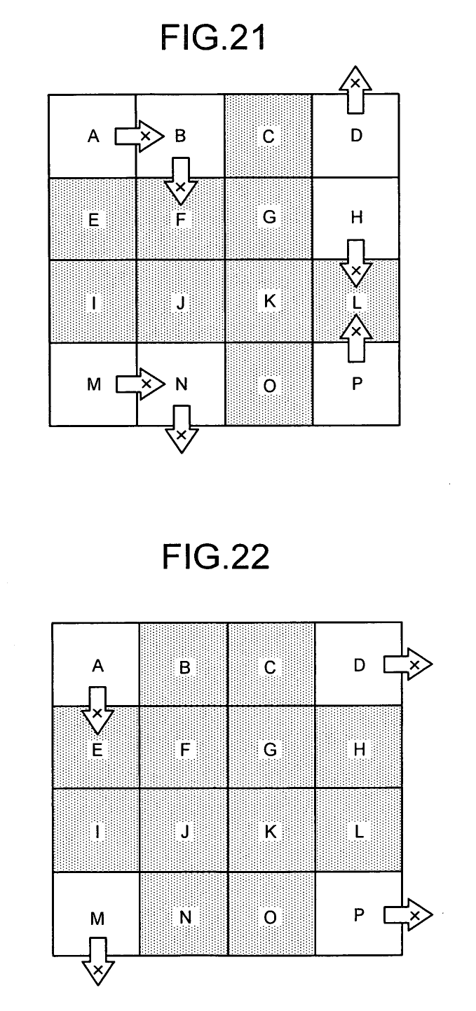

As shown in FIG. 21, “E”, “C”, and “O” have ended communication, and display a corresponding part of the image, respectively. Since “L” has already ended communication, “H” and “P” do not transmit image data to “L”. Since “F” has already ended communication, “B” does not transmit image data to “F” that is positioned below “B”. Since “B” has thus ended communication, “A” does not transmit image data to “B” that is positioned at the left side of “A”. Since there is no communication party below “N”, “N” does not transmit image data to below thereof. Since “N” has ended communication, “M” does not transmit image data to “N” that is positioned at the right side thereof. Since there is no communication party above “D”, “D” does not transmit image data to above thereof.

As shown in FIG. 22, “B”, “N”, and “H” have ended communication, and display a corresponding part of the image, respectively. Since “E” has already ended communication, “A” does not transmit image data to “E” that is positioned below “A”. Since there is no communication party below “M”, “M” does not transmit image data to below thereof. Since there is no communication party at the right side of “D” and “P”, “D” and “P” do not transmit image data to the right side of “P” and “D”, respectively.

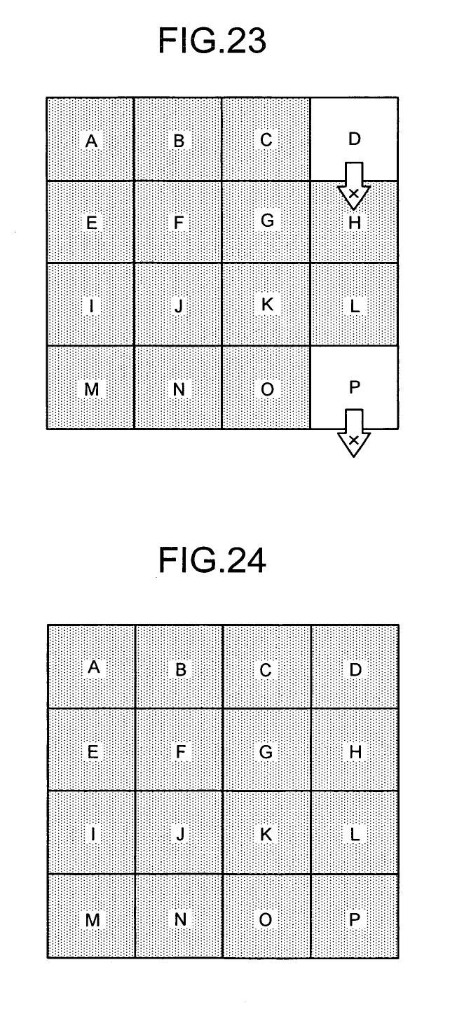

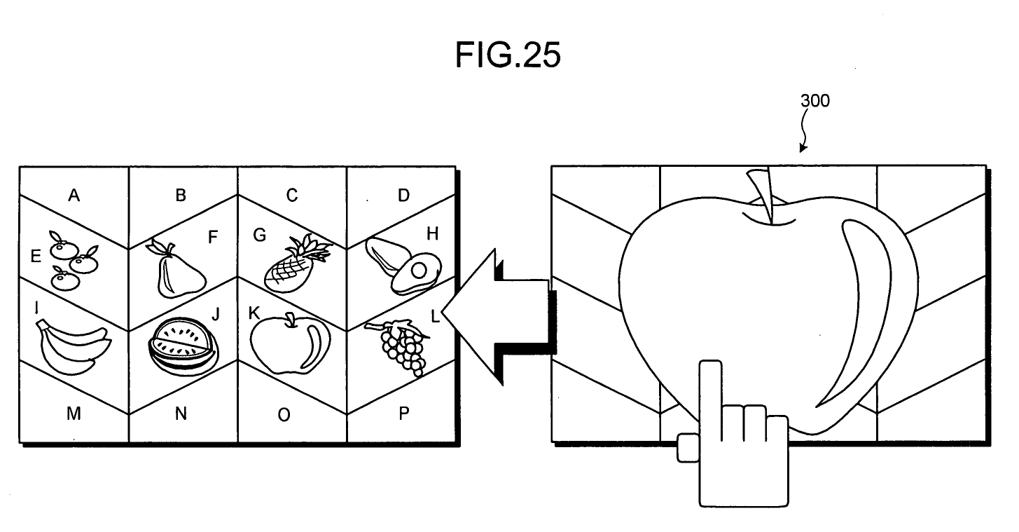

As shown in FIG. 23, “A” and “M” have ended communication, and display a corresponding part of the image, respectively. Since “H” has already ended communication, “D” does not transmit image data to “H” that is positioned below “D”. Since there is no communication party below “P”, “P” does not transmit image data to below thereof. As shown in FIG. 24, “D” and “P” have ended communication, and display a corresponding part of the image, respectively. With this arrangement, all the image displays can display the corresponding parts of the image, thereby displaying one enlarged image as a whole.

FIG. 25 is a schematic for illustrating a start of an image reduction process. One enlarged image displayed on the total image displays of the display device 300 by the above process is next displayed on only the original image display, and each image display displays the image data stored in each semiconductor layer, as follows. When the display surface of any one of the image displays that constitute the display device 300 is tapped twice with fingers, each image display can independently display its own image. This operation is explained in detail below.

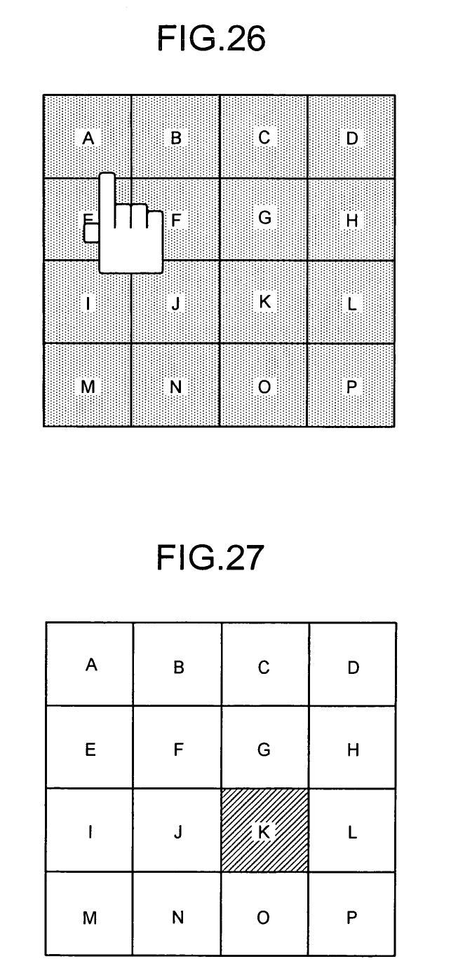

FIG. 26 and FIG. 27 are schematics for illustrating a process at the time of performing reduced image display. In displaying a reduced image, as shown in FIG. 26, when the display surface of any one of the image displays “A” to “P” is tapped twice with fingers, the image displays simultaneously stop the enlarged display of one image, and each image display displays the original image independently. For example, the enlarged display of the image of the image display “K” using the total image displays is changed to the reduced display of this image in the image display “K”.

A series of process of the display device 300 according to the embodiment of the present invention is explained below with reference to a flowchart.

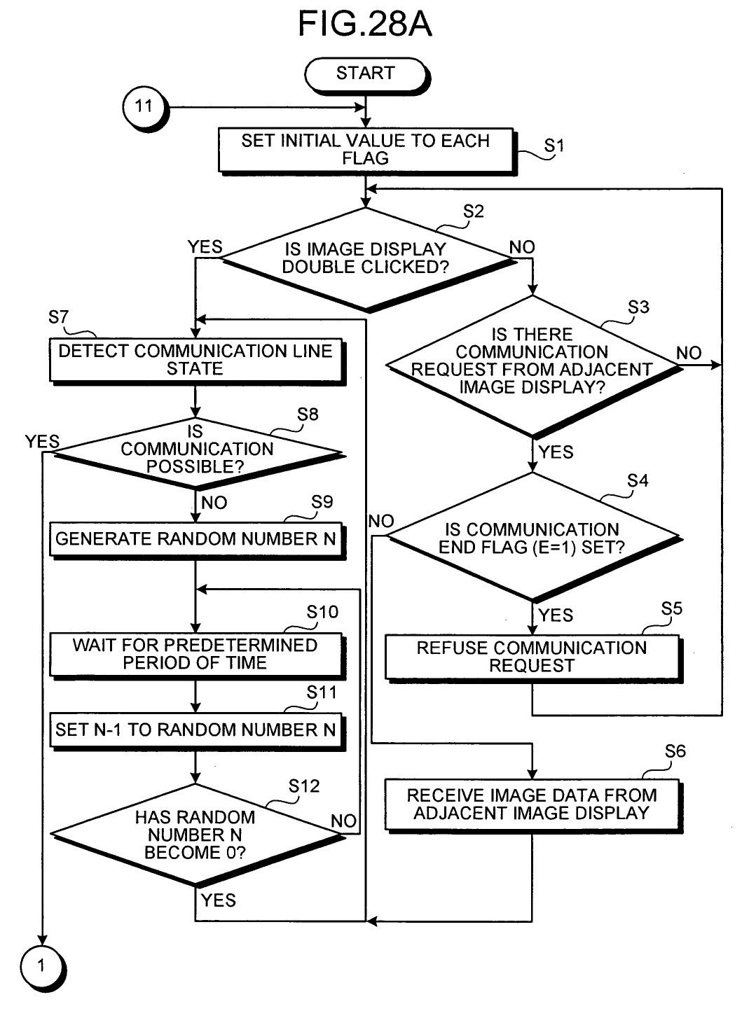

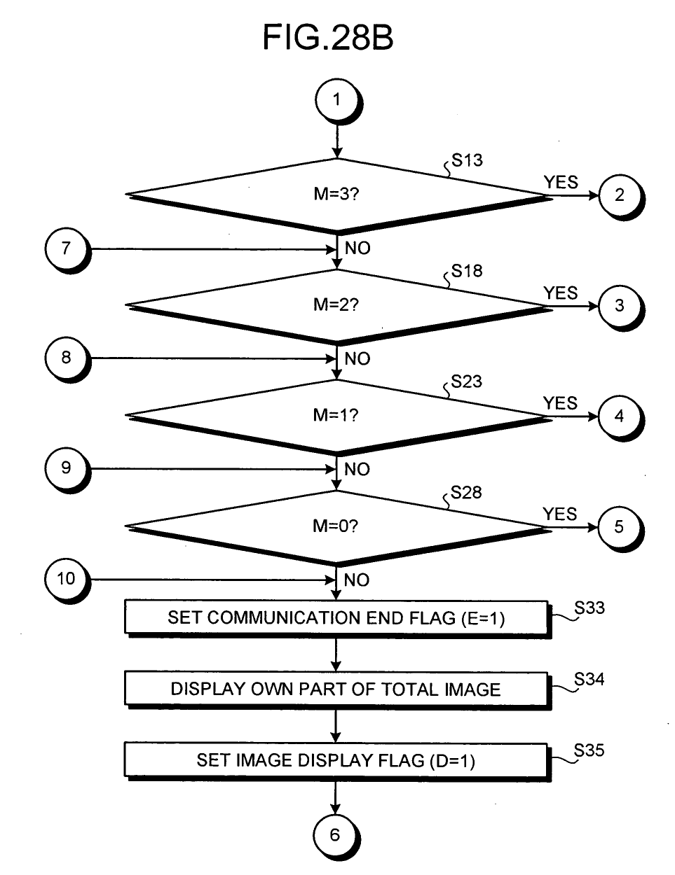

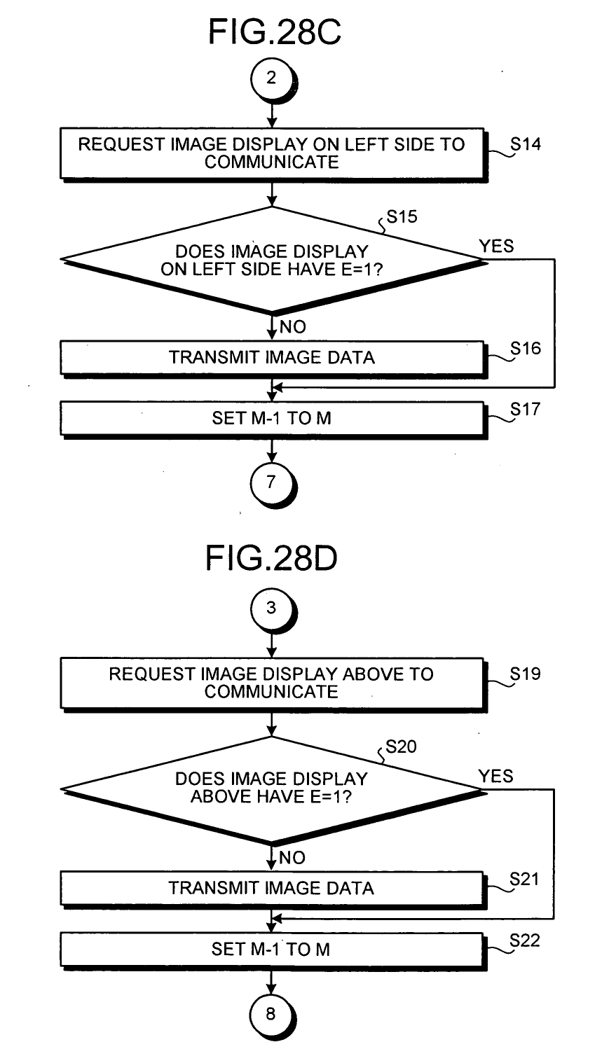

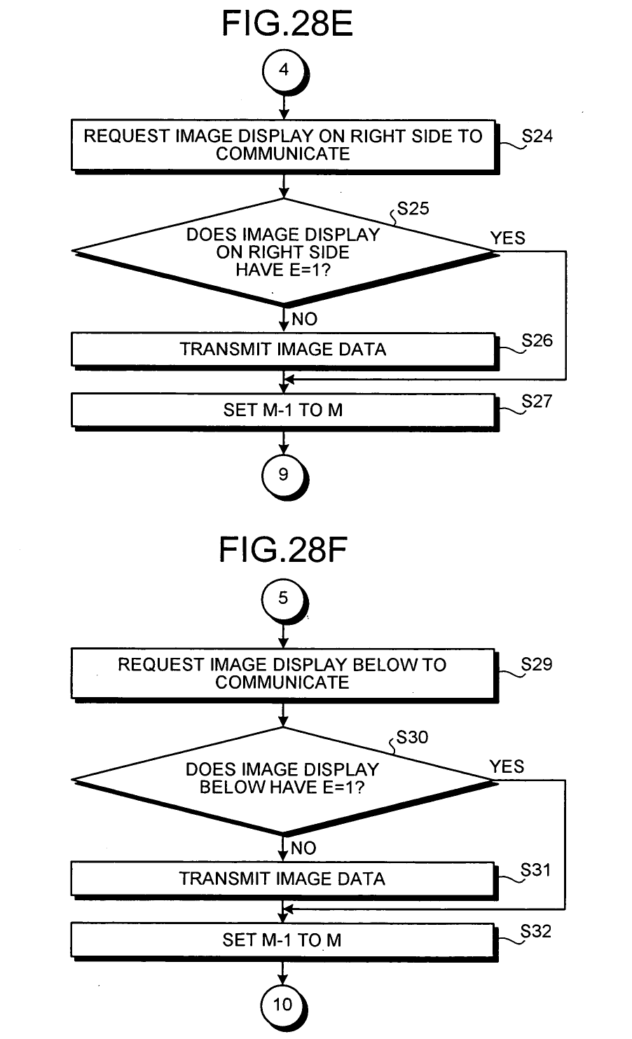

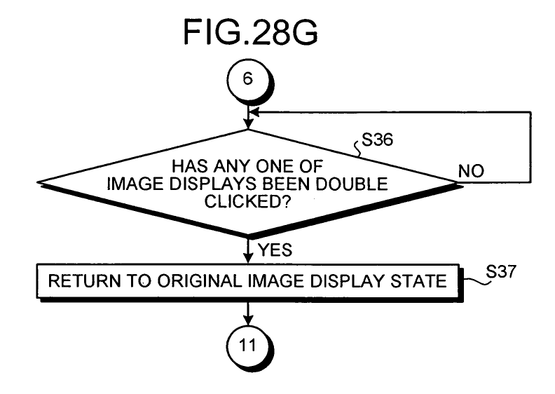

FIG. 28A to FIG. 28G are flowcharts of processing performed by the display device according to the embodiment of the present invention. In the flowcharts, E, D, and M denote a communication end flag, an image display flag, and a communication direction flag, respectively. E=0 means that communication has not ended, and E=1 means that communication has ended. D=0 means display of an image based on image data that is originally held by an image display concerned. D=1 means display of a relevant part of the image to be displayed by an image display concerned. M=3 means communication with an image display that is positioned at the left side. M=2 means communication with an image display that is positioned at the top. M=1 means communication with an image display that is positioned at the right side. M=0 means communication with an image display that is positioned at the bottom.

First, with reference to the flowchart shown in FIG. 28A, initial values are set to each flag (step S1). Initial values are set as E=0, D=0, and M=3. Next, it is detected whether an image display is double clicked (step S2). In the display device 300 according to the present embodiment, when the user double clicks a display surface of an image display on which an image to be displayed by expansion is displayed, the process of performing an enlarged display is started. When there is no image display that detects a double click (step S2: No), it is detected whether there is a communication request from an adjacent image display (step S3). When there is no communication request from an adjacent image display (step S3: No), the process returns to step S2.

When there is a communication request from an adjacent image display at step S3 (step S3: Yes), it is detected whether a communication end flag (E=1) is set (step S4). When the communication end flag is set (step S4: Yes), the communication request is refused (step S5). Thereafter, the process returns to step S2. On the other hand, when the communication end flag is not set (step S4: No), the image display receives image data from an adjacent image display (step S6). Thereafter, the process returns to step S7.

When there is an image display that detects a double click at step S2 (step S2: Yes), or when the process at step S6 ends, a communication line state is detected (step S7), and whether image data can be communicated with this image display is detected (step S8). When it is detected that image data cannot be communicated with this image display (step S8: No), a random number N is generated (step S9), and the corresponding image display waits for a certain period of time (step S10). Next, N−1 is set to the random number N (step S11). It is detected whether the random number N has changed to 0 (step S12). When the random number N has changed to 0 (step S12: Yes), the process returns to step S7. On the other hand, when the random number N is not 0 (step S12: No), the process returns to step S10. The process at steps S9 to S12 is a standby process to be performed when communication cannot be performed between image displays.

When it is detected at step S8 that image data can be communicated with this image display (step S8: Yes), it is detected whether M=3 (step S13) (see FIG. 28B). When M=3 (step S13: Yes), the image display requests an image display that is adjacent at the left side to communicate with the self (step S14) (see FIG. 28C). It is detected whether the image display that is adjacent at the left side has E=1 (step S15). When the image display that is adjacent at the left side does not have E=1 (step S15: No), image data is transmitted to this image display (step S16). On the other hand, when an image display that is adjacent at the left side has E=1 at step S15 (step S15: Yes), or when the process at step S16 has ended, M−1 is set to M (step S17). Thereafter, the process proceeds to step S18 in FIG. 28B.

When it is not M=3 at step S13 in FIG. 28B (step S13: No), or when the process at step S17 in FIG. 28C has ended, it is determined whether M=2 (step S18). When M=2 (step S18: Yes), the image display requests an image display that is adjacent above to communicate with the self (step S19) (see FIG. 28D). It is detected whether the image display that is adjacent above has E=1 (step S20). When the image display that is adjacent above does not have E=1 (step S20: No), image data is transmitted to this image display (step S21). On the other hand, when an image display that is adjacent above has E=1 at step S20 (step S20: Yes), or when the process at step S21 has ended, M−1 is set to M (step S22). Thereafter, the process proceeds to step S23 in FIG. 28B.

When it is not M=2 at step S18 in FIG. 28B (step S18: No), or when the process at step S22 in FIG. 28D has ended, it is determined whether M=1 (step S23). When M=1 (step S23: Yes), the image display requests an image display that is adjacent at the right side to communicate with the self (step S24) (see FIG. 28E). It is detected whether the image display that is adjacent at the right side has E=1 (step S25). When the image display that is adjacent at the right side does not have E=1 (step S25: No), image data is transmitted to this image display (step S26). On the other hand, when an image display that is adjacent at the right side has E=1 at step S25 (step S25: Yes), or when the process at step S26 has ended, M−1 is set to M (step S27). Thereafter, the process proceeds to step S28 in FIG. 28B.

When it is not M=1 at step S23 in FIG. 28B (step S23: No), or when the process at step S27 in FIG. 28E has ended, it is determined whether M=0 (step S28). When M=0 (step S28: Yes), the image display requests an image display that is adjacent below to communicate with the self (step S29) (see FIG. 28F). It is detected whether the image display that is adjacent below has E=1 (step S30). When the image display that is adjacent below does not have E=1 (step S30: No), image data is transmitted to this image display (step S31). On the other hand, when an image display that is adjacent below has E=1 at step S30 (step S30: Yes), or when the process at step S31 has ended, M−1 is set to M (step S32). Thereafter, the process proceeds to step S33 in FIG. 28B.

When it is not M=0 at step S28 in FIG. 28B (step S28: No), or when the process at step S32 in FIG. 28F has ended, a communication end flag (E=1) is set (step S33). Subsequently, the own part of the total image is displayed (step S34). Specifically, the image display saves the image data that has been held so far by the self, and displays the responsible part of the total image based on the image data received this time. Next, an image display flag (D=1) is set (step S35).

Next, it is detected whether an image display is double clicked (step S35) (see FIG. 28G). In the display device 300 according to the present embodiment, after an enlarged image is displayed, when the user double clicks a display surface of any one of the image displays, the initial image display state is obtained (that is, each image display displays an independent image). When there is no image display that detects a double click (step S36: No), the process at step S36 is performed again. On the other hand, when there is an image display that detects a double click (step S36: Yes), the original image display state is obtained (step S37). Specifically, each image display simultaneously stops the enlarged display of an image, and returns to the original image display (each image display displays the independent image). Thereafter, the process returns to step S1 in FIG. 28A.

As explained above, according to the present embodiment, the display device can expand one image displayed on one image display, thereby displaying an enlarged image in the total displays of the display device, by a simple operation. The display device can also compress an enlarged image displayed on the total image displays, thereby displaying the reduced image in one image display by a simple operation.

In the above embodiment, image data is transmitted and received following the rules (1) to (7). The display device can switch between an enlarged display and a reduced display, as explained with reference to FIG. 12 and FIG. 25. It is needless to mention that the image display can be performed according to other methods. In place of the method of transmitting image data from a double-clicked image display, a controller of the image display A can detect the double-clicked image display, and the image display A can distribute the image data of the image displayed on the detected image display, to each image display.

Each image display can be controlled based on the same program. The image display that constitutes the display device can smoothly transmit image data to other image displays, irrespective of whether the image display is positioned at the center or at the periphery of the display device.

In the display device according to the present embodiment, all image displays are not necessarily required to hold the same image data. When image data that is held in any one of the image displays is transmitted to another image display, an enlarged display of this image can be performed easily. Therefore, the display device as a whole can hold many kinds of image data and use these image data, thereby performing an efficient image processing. Since each image display regularly transmits image data sequentially in four directions, the image data can be transmitted to at least one image display through one secured communication route, even when the image data cannot be communicated through communication routes in three directions out of the four directions (for example, when an unrecoverable collision occurs or when a communication element is damaged). Therefore, the display device is strong against defect, damage, and error.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

The present document incorporates by reference the entire contents of Japanese priority document, 2006-041466 filed in Japan on Feb. 17, 2006.

What is claimed is:

1. A display device comprising:
a display unit including a plurality of displays, and configured to be foldable;
a storage unit configured to store data including image data; and
a controller configured to control the display unit to display an image, and to switch a display mode of the display unit between a first display mode and a second display mode, the first display mode in which the display unit displays a different image on each of the displays, the second display mode in which the display unit displays a single image selected from among images displayed on the displays, in an enlarged size.

2. The display device according to claim 1, further comprising a detector configured to detect an input from a user, wherein
the controller is configured to switch the display mode based on a result of detection by the detector.

3. The display device according to claim 1, wherein
the storage unit includes
a first storage unit provided in each of the displays; and
a second storage unit provided in the display unit, and having a larger capacity than that of the first storage unit.

4. The display device according to claim 3, wherein
the controller is configured to control, in the first display mode, the display unit to display an image on the displays using image data stored in the first storage unit.

5. The display device according to claim 1, wherein
each of the displays further includes a communication unit configured to communicate with other displays, and
the controller is configured to distribute image data corresponding to the single image, to other displays via the communication unit, at the time of switching the display mode from the first display mode to the second display mode.

6. The display device according to claim 5, wherein
the first storage unit is configured to store first image data used in the first display mode, and second image data used in the second display mode, and
the second image data is the image data distributed via the communication unit.

7. The display device according to claim 6, wherein
the controller is configured to control the image display to display an image using the first image data in the first display mode, and to control the image display to display an image using the second image data in the second display mode.

8. The display device according to claim 1, wherein
the displays are connected to each other via flexible connection members.

9. The display device according to claim 8, wherein
the display unit is configured to be foldable in a mountain fold and a valley fold at each joint at which the displays are connected to each other, and to be easily opened and closed by pulling and pushing the display unit in one axial direction.
